(19) United States
(12) Patent Application Publication
(10) Pub. No.: US 2001/0055076 A1
(43) Pub. Date: Dec. 27, 2001

(54) Reflective liquid crystal display apparatus

(76) Inventors: Keizou Ochi, Takasuki-shi (JP); Mitsuyoshi Miyai, Sakai-shi (JP); Hiroshi Oshitani, Amagasaki-shi (JP)

Correspondence Address: SIDLEY AUSTIN BROWN & WOOD, 717 NORTH HARWOOD, SUITE 3400, DALLAS, TX, 75201, US

(21) Appl. No.: 09/844,960

(22) Filed: Apr. 27, 2001

(30) Foreign Application Priority Data
Apr. 28, 2000 (JP) 2000-130445
Jun. 28, 2000 (JP) 2000-194632
Jun. 28, 2000 (JP) 2000-194638
Apr. 26, 2001 (JP) 2001-129464

(51) Int. Cl. G02F 1/1335

(52) U.S. Cl. 349/63

(57) ABSTRACT

A reflective liquid crystal display apparatus includes a liquid crystal panel having a plurality of liquid crystal layers. Each liquid crystal layer includes a cholesteric liquid crystal that changes between a transmission state in which the liquid crystal transmits visible light and a reflection state in which the liquid crystal reflects a selected part of the visible light. Also, the apparatus includes a light guide having a front, a rear, and a peripheral surface connecting between front and rear surfaces. The light guide is positioned so that the rear surface opposes the liquid crystal panel. In this arrangement, light transmitted from the peripheral surface is transmitted through the rear surface to the liquid crystal panel.

### FIELD OF THE INVENTION

The present invention relates to a reflective liquid crystal display apparatus. In particular, the present invention relates to a reflective liquid crystal display device, which is equipped with a front light unit for an illumination of a liquid crystal element.

### BACKGROUND OF THE INVENTION

Conventionally, there has been known a reflective liquid crystal display device or panel that uses light transmitted through a front surface of the panel, adjacent to a viewer, for an image display. In general, the reflective liquid crystal panel can display the image only by the light entered through its front surface. This reduces a consumption of an electric power, which is so advantageous over a back-light liquid crystal display device that uses light entered through a back surface of the panel, away from the viewer, for the image display. Actually, however, no conventional reflective liquid crystal panel can reproduce a sufficiently bright image only with a natural or available light.

Another front-light liquid crystal display device has been known, which includes a reflective liquid crystal panel and a transparent plate provided adjacent the front surface of the liquid crystal panel. According to the device, light is guided into the transparent plate through its peripheral surface. The light is then entered through a back surface of the transparent plate into the liquid crystal panel.

The reflective liquid crystal panel is made of a single liquid crystal layer. Also, in order to reproduce a full color image, the single layer liquid crystal panel supports a plurality of independent color elements or micro-color films. Each color element has three portions capable of reproducing respective colors, e.g., red, blue, and green. With the panel, each pixel of the image is formed by neighboring, three pixel portions of the color elements. Therefore, when displaying red for example, only the red pixel portion is energized while the remaining blue and green pixel portions are de-energized. This means that only one third of the pixel contributes to the actual image formation, which results in that the resultant image is rather dark.

One technique for overcoming this problem is to increase a light intensity of the front light. However, the increase of the light intensity trades off increases of a black density and a light diffusion, decreasing a contrast in the resultant image. Besides, the power consumption is increased, which deteriorates an application of the reflective liquid crystal panel to mobile devices.

### SUMMARY OF THE INVENTION

Therefore, an object of the present invention is to provide a reflective liquid crystal display device capable of reproducing an image with a sufficient brightness and contrast. Another object of the present invention is to provide a reflective liquid crystal display device with the minimum power consumption.

Accordingly, a reflective liquid crystal display apparatus includes a liquid crystal panel having a plurality of liquid crystal layers. Each liquid crystal layer includes a cholesteric liquid crystal that changes between a transmission state in which the liquid crystal transmits visible light and a reflection state in which the liquid crystal reflects a selected part of the visible light. Also, the apparatus includes a light guide having a front surface, a rear surface, and a peripheral surface connecting between front and rear surfaces. The light guide is positioned so that the rear surface opposes the liquid crystal panel. In this arrangement, light transmitted from the peripheral surface is entered through the rear surface to the liquid crystal panel.

### BRIEF DESCRIPTION OF THE DRAWINGS

FIG. 1 is an enlarged schematic cross sectional view of an LCD device according to the first embodiment of the present invention;

FIG. 2 is an enlarged schematic cross sectional view of an LCD panel in the LCD device in FIG. 1;

FIG. 3 is an enlarged partial cross sectional view of a front surface of a light guide in the LCD device in FIG. 1;

FIG. 4 is an enlarged schematic cross sectional view of a modified LCD device according to the first embodiment of the present invention;

FIGS. 5A and 5B are enlarged schematic cross sectional views of another modified LCD devices according to the first embodiment of the present invention;

FIGS. 6A and 6B are front views of another modified LCD devices according to the first embodiment of the present invention;

FIG. 7 is a front view of another modified LCD device according to the first embodiment of the present invention;

FIG. 8 is a cross sectional view of the LCD device in FIG. 7;

FIG. 9 is also a cross sectional view of the LCD device in FIG. 7;

FIG. 10 is an enlarged schematic cross sectional view of an LCD device according to the second embodiment of the present invention;

FIG. 11 is graph showing a wavelength versus reflectance relationship of the LCD panel for green light;

FIGS. 12A and 12B are schematic cross sectional views, showing reflections of light by the LCD panel in the planer and focal conic states;

FIG. 13 is graph showing a wavelength versus reflectance relationship of the LCD panel for blue light;

FIG. 14 is graph showing a wavelength versus reflectance relationship of the LCD panel for red light;

FIG. 15 is a cross sectional view of another LCD device according to the second embodiment of the present invention;

FIG. 16 is graph showing a wavelength versus relative intensity relationship of light emitted from a light source;

FIG. 17 is an enlarged schematic cross sectional view of an LCD device according to the third embodiment of the present invention;

FIG. 18A to 18D show reflection and/or transmission of light through a liquid material in the planer and focal conic states;

FIG. 19 is a graph showing a reflectance versus contrast relationship for different contrasts;

FIG. 20 is an enlarged schematic cross sectional view of a modification of the LCD device according to the third embodiment of the present invention;

FIG. 21 is an enlarged schematic cross sectional view of another modification of the LCD device according to the third embodiment of the present invention; and

FIG. 22 is an enlarged schematic cross sectional view of another modification of the LCD device according to the third embodiment of the present invention.

### DETAILED DESCRIPTION OF THE PREFERRED EMBODIMENTS

With reference to the drawings, preferred embodiments of the present invention will be described hereinafter.

First Embodiment

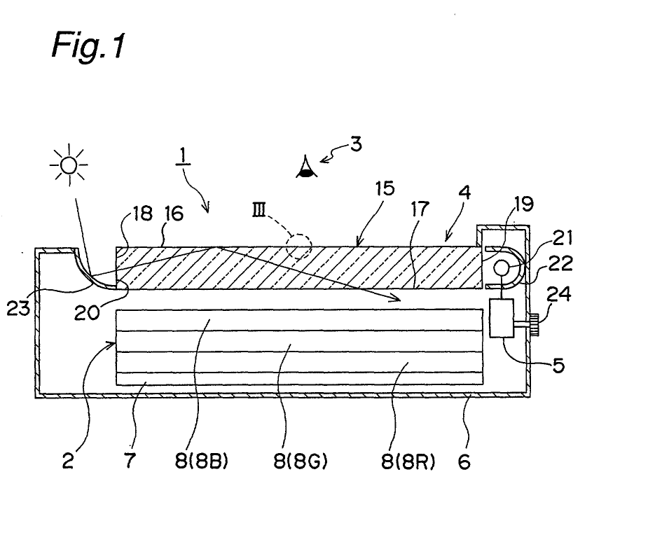

FIG. 1 shows a liquid crystal display device (LCD), generally indicated by reference numeral 1. In general, LCD 1 has a liquid crystal (LC) panel or element 2, a front light unit 4 positioned on or above the LC panel 2 (on one side adjacent a viewer 3) for transmission of light into the LC panel 2, and a display controller 5 for controlling the LC panel 2, which are received by a housing 6.

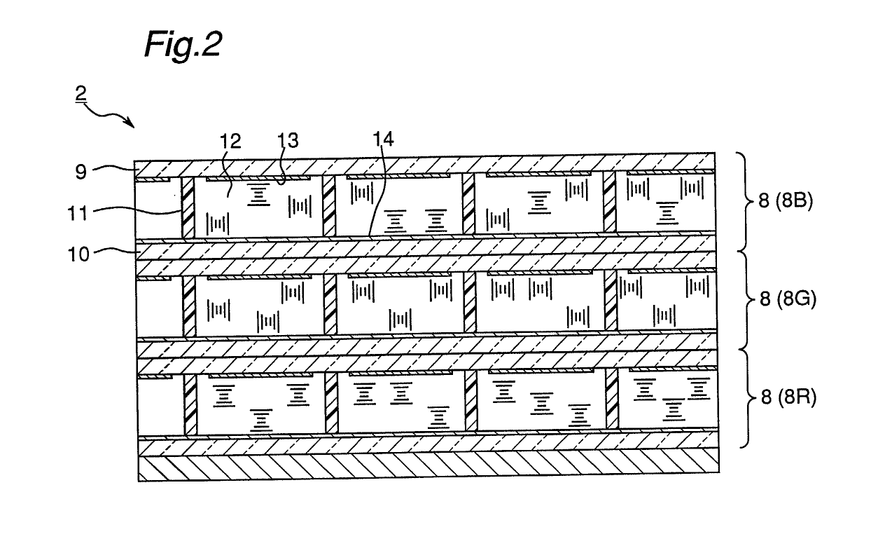

The LC panel 2 has a light absorbing layer 7 provided on one side away from the front light unit 4, which is capable of substantially absorbing all visible light. The light absorbing layer 7 supports three display layers (red layer 8R, green layer 8G, and blue layer 8B) positioned one on top the other, for displaying three different colors, i.e., red, green, and blue. As best shown in FIG. 2, each layer 8 has an upper substrate 9 and a lower substrate 10 spaced a certain distance from the upper substrate 9. The upper and lower substrates 9 and 10 are made of transparent materials. The upper substrate 9 is bonded on the lower substrate 10 through a suitable resin adhesive 11 provided therebetween so that a certain gap is defined between the upper and lower substrates. The gap is filled with a liquid crystal 12. Although not shown in the drawing, a number of spherical spacers are positioned between the upper and lower substrates to keep the gap constant.

A lower surface of the upper substrate 9, opposing the lower substrate 10, bears a plurality of transparent, strip-like upper electrodes 13 arranged at regular intervals. Likewise, an upper surface of the lower substrate 10, opposing the upper substrate 9, bears a plurality of transparent, strip-like lower electrodes 14 arranged at regular intervals. The upper and lower substrates 9 and 10 are assembled so that the upper electrodes 13 cross the lower electrodes 14 so that intersections of the upper and lower electrodes define respective pixels in the LCD device 1.

Used for the liquid crystal 12 in each display layer 8 is a cholesteric liquid crystal 12 capable of reflecting a specific part of visible light. In this embodiment, the display layer 8B positioned on the viewer's side includes a liquid material that reflects blue light, the middle display layer 8G a liquid material that reflects green light, and the bottom display layer 8R a liquid material that reflects red light.

Although each display layer 8 includes both upper and lower substrates, the neighboring layers can share one substrate so that the one substrate is used both for the lower substrate of the upper layer and for the upper substrate of the lower layer. This reduces the number of substrates, decreasing a manufacturing cost of the LCD device and increasing a brightness of an image to be displayed on the LCD.

In response to a voltage applied between the upper and lower electrodes 13 and 14 in each display layer 8, each layer changes between a transmission state in which the liquid crystal allows the visible light to pass therethrough and a reflection state in which the corresponding part of the visible light, having a certain wavelength, is reflected therefrom. Therefore, where one display layer is in the reflection state but others are in the transmission state, only the reflection state display layer reflects the corresponding part of the visible light to provide its color, which is observed by the viewer. Contrary to this, where the display layer is in the transmission state, the light passes through the layer without being reflected by the layer. This mean that a desired color is provided by setting the display layer associated with the color into the reflection state and also setting the remaining display layer or layers positioned on the viewer side into the reflection state display layer. If all of the display layers are set transmission state, the incident light is absorbed by the light absorbing layer 7, providing a background color, i.e., black.

The cholesteric liquid crystal in the display layer may be selected from any liquid crystal including a cholesteric liquid crystal capable of maintaining a cholesteric phase at atmospheric temperature or another liquid material including a nematic liquid crystal with a suitable chiral material. The selected liquid crystal takes a planar state when it is biased with a relatively high voltage and takes a focal conic state when it is biased with a relatively low voltage. The voltage may be in the form of pulse. In addition, when biased with an intermediate voltage, the liquid crystal takes an intermediate state which is a combination of planer and focal conic states. The cholestelic liquid crystal in the planer state selectively reflects light having a wavelength indicated by the following equation:

λ=P·n

wherein λ represents the wavelength of light to be reflected, P represents a helical pitch of the liquid crystal, and n represents a mean refractive index of the liquid crystal. If the wavelength of light to be reflected ranges in the infrared region, the cholesteric liquid in the focal conic state diffuses the visible light. If, on the other hand, the wavelength of light to be reflected ranges below the infrared region, the diffusion is reduced and the visible light is transmitted therethrough. The cholesteric lquid crystal in the intermediate state between the planer and focal conic states represents a halftone of the color. Therefore, the LC panel 2 with the light absorbing layer 7 positioned away from the viewer changes the color of the displaying image between one color (green, red, or blue provided in the planer state), black color, and halftone color thereof.

For example, the LC panel 2 presents a red color when the cholesteric liquid crystals in the blue and green display layers 8B and 8G take the focal conic state (transmission state) and the cholesteric liquid crystal in the red display layer 8R takes the planer state (reflection state). A yellow is provided when the cholesteric liquid crystal in the blue layer 8B takes the focal conic state (transmission state) and the cholesteric liquid crystals in the green and red layers 8G and 8R take the planer state (reflection state). Like this, simply by changing each of the color display layers between the transmission and reflection states, a variety of colors including red, green, blue, white, cyan, magenta, yellow, and black can be provided. In addition, by setting each of the color display layers into the intermediate state, various halftone colors can be presented. This means that a full color image can be reproduced through the additive process.

Each of the states of the liquid crystal, i.e., focal conic, planer and intermediate states, is maintained even if the voltage that has been applied to the electrodes is turned off. Therefore, it can be said that the liquid crystal has a memory characteristic. Also, since the color display layers are mounted one on top the other rather than being arranged in the same plane, the LCD device provides a more bright full color image with keeping the resolution than the conventional reflective LCD device in which various color portions are arranged at different places in the same plane in the form of mosaic or stripes for displaying the full color image.

Referring back to FIG. 1, the front light unit 4 has a light guide 15 in the form of plate. The light guide 15, which is made from a thin plate of relatively rigid material, has a front surface 16, a rear surface 17, and a peripheral surface 18 connecting between peripheral edges of the front and rear surfaces. In this embodiment, the peripheral surface 18 includes a pair of opposing surface portions 19 and 20.

The unit 4 further includes a light source 21 positioned adjacent the peripheral surface portion 19. The light source 21, which is made of an LED emitting white light or fluorescent lamp, is surrounded at its portion away from the peripheral surface portion 19 by a substantially half-round reflector 22 so that light from the light source 21 is reflected by the reflector 22 and then directed through the peripheral surface portion 19 into the light guide 15.

Also, the unit 4 includes a lighting portion 23 or light collector positioned adjacent another peripheral surface portion 20. In this embodiment, the lighting portion 23 is made from a curved reflector so that available light provided from the sun, for example, is reflected by the reflector and then directed through the peripheral surface portion 20 into the light guide 15.

In order to control an intensity of light emitted from the light source 21 according to the amount of light available and thereby reduce a power consumption of the LCD device 1, the display controller 5 has a control 24 for controlling the light intensity of the light source 21. The light control 24 may be in to form of dial or volume by which the viewer can manually control the brightness of the image displayed on the LCD device 1. Alternatively, the display controller 5 may automatically control the intensity of light emitted from the light source 21 in response to the intensity of available light which may be detected by a suitable light detector not shown.

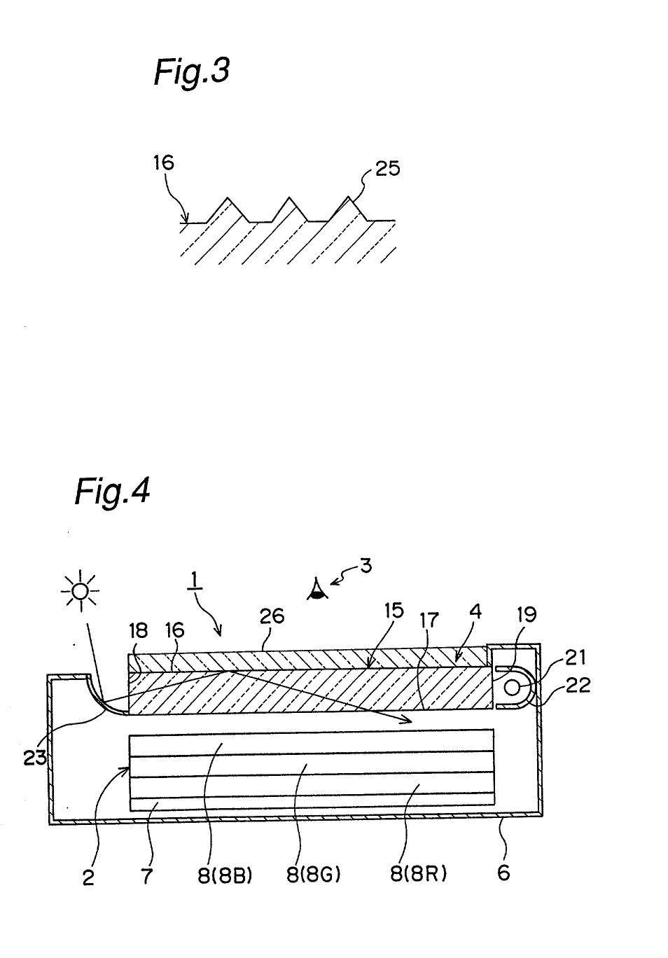

In this embodiment, used for the light guide 15 is a rectangular transparent acrylic plate, for example. As shown in FIG. 3, the front surface 16 of the light guide 15 has a number of small convex or concave portions 25 formed therein for effectively reflecting light from the lighting portion 23 toward the LC panel 2. Although the portion 25 has a conical configuration, it may have another configuration such as truncated cone or pyramid. Also, the portion 25 may be a wall or groove defined in the surface. In addition, the rear surface 17 of the light guide 15 may be covered with an anti-reflection film not shown.

According to the LCD device 1 so constructed, light reflected from one display layer may be combined with another light reflected from the upper and/or lower display layer, which ensures an elevated brightness for the displaying image. Also, each pixel can emit various colors, which ensures an elevated resolution and image density than the conventional reflective LCD panel in which one pixel is composed of three separate portions. Also, the decrease in the brightness caused by the existence of the light guide is compensated by the increase of light introduced in light guide. This results in a higher contrast in the display image than the reflective LCD panel with micro-color films. This in turn means that even the small amount of light introduced in the light guide provides a clear and bright image, allowing the power consumption of the front light to decrease.

According to the above-described LCD device 1, the light source 21 is turned on for lighting in the dark place where no sufficient light is available from outside. On the other hand, where a sufficient light is available from outside, i.e., in the bright place, light is introduced not only through the front surface 16 but also the peripheral surface portion 20 into the light guide 15. Therefore, the display image is more clear and bright than that of the conventional LCD device in which light is introduce only through the front surface. Further, according to the above-described LCD device, even in the place where the conventional device can display a clear image only with an aid of the light source, the recognizable clear image can be displayed only with the light available from outside. Therefore, the power consumption will be reduced considerably. Besides, where sufficient natural light is available, the brightness of the light source 12 can be decreased or turned off to reduce its power consumption.

Preferably, as shown in FIG. 4, a protection member or layer 26 made of transparent material is provided on the front surface of the light guide. The protection layer may be a touch panel. In this instance, the protection layer reflects a part of light transmitted into the front surface of the light guide. The decrease of light introduced through the front surface of the light guide is compensated with light provided from the lighting portion to result in a clear and bright image.

Although in the previous embodiment the LC panel 2 is spaced away from the light guide 15, it may be arranged in contact with the light guide.

Also, the light guide may be made of curved plate. In this instance, a relatively flexible liquid panel may be arranged along the rear surface of the curved light guide.

Further, a transmission type liquid crystal may be used instead of the reflection type liquid crystal. In this instance, a reflection plate is preferably positioned on the back of the liquid crystal panel 4 instead of the light absorbing layer.

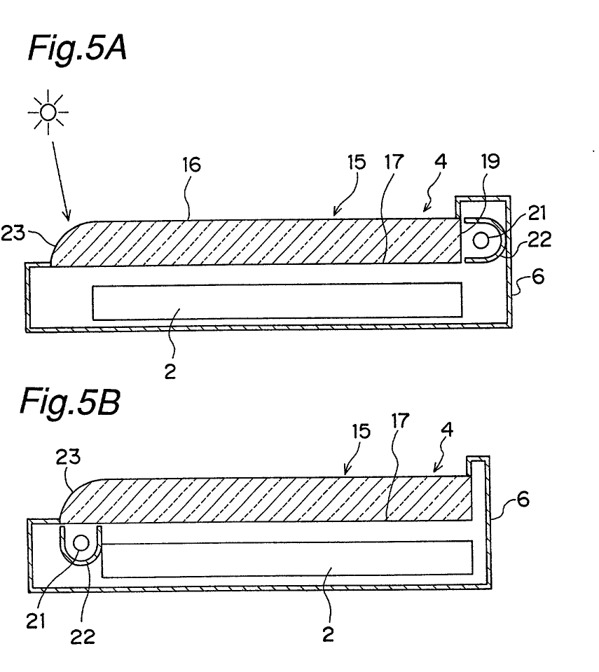

The lighting portion may be provided in another way. For example, as shown in FIG. 5A, the lighting portion 23 may be defined by an outward curved peripheral surface portion of the light guide 15. The configuration of the lighting portion 23 defined in the light guide may be a straight inclined plane or steps. Alternatively, as shown in FIG. 5B, the light source 21 may be positioned adjacent the lighting portion 23. In this instance, light from the light source 21 is almost reflected from the lighting portion 23 or surface toward the opposite side of the light guide 15. Therefore, by increasing a surface area of the lighting portion 23, more light can be introduced into the LC panel 2, increasing the brightness of the display image.

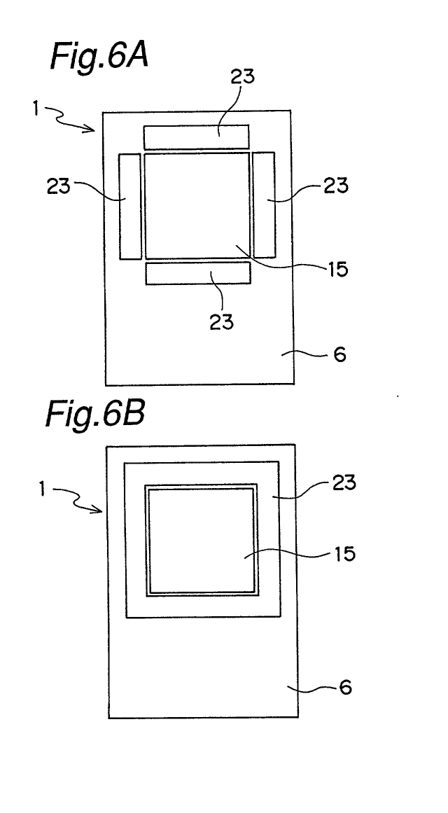

The lighting portions may be arranged in different ways. For example, in the embodiment in FIG. 6A, a plurality of lighting portions 23 are each arranged along four edges of a rectangular light guide 15. In another embodiment in FIG. 6B, the lighting portion 23 is arranged continuously along the peripheral of the light guide 15. For those embodiments, the light source is preferably arranged along the lighting portions as shown in FIG. 5B, so that light from the light source is directed through the lighting portion 23 into the interior of the light guide 15.

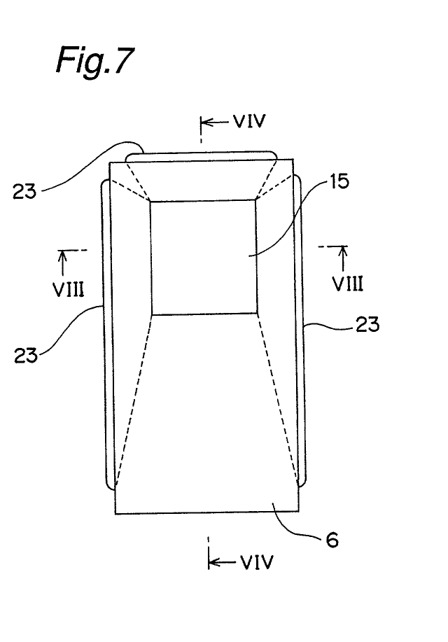

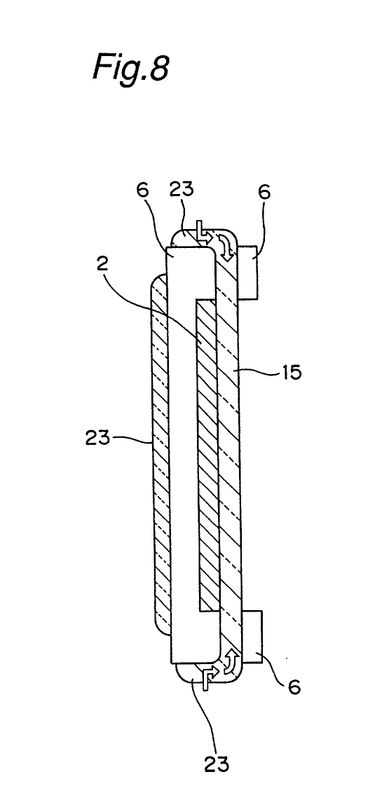

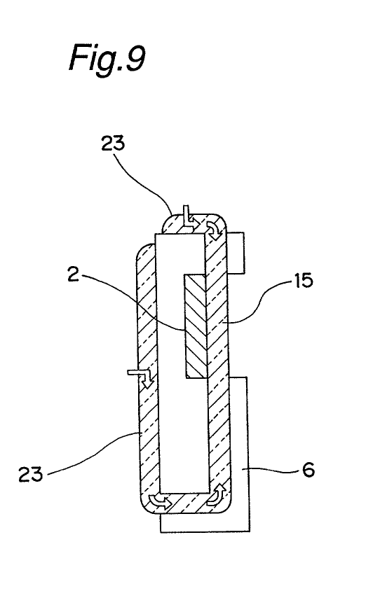

FIGS. 7 to 9 show another arrangements of the lighting portions. As can be seen from the drawings, the lighting portions 23 are also provided at the side, upper and rear portions of the housing 6. Those lighting portions 23 are optically connected to the light guide 15 positioned on the front portion of the LC panel 4 so that light received by the lighting portions 23 is directed through the light guide 15 into the LC panel 4. In those arrangements, in order to minimize light that can leak from a passage connecting between the lighting portions 23 and the light guide 15, a surface of the lighting portion 23 may be coated with a material having a reduced reflectance than that of the lighting portion 23. This causes that most of light entered from the lighting portion is transmitted to the light guide 15 as it is reflected at several portions of the coated surface. Even in those arrangements, the rear surface of the light guide 15 may be coated with an anti-reflection layer. Also, the light guide 15 may be provided in its front surface with a number of small convex and/or concave portions, so that light introduced in the light guide is guided effectively toward the LC panel 4.

Accordingly, the above-described LCD device with a plurality of superimposed liquid crystal layers enhances the light reflection and the resolution of the display image. Therefore, notwithstanding the existence of the light guide, the device displays a high contrast full-color image. Also, even when only a limited amount of light is introduced in the light guide through its front surface, the device ensures a high quality and clear image. This means that the power consumption of the device will be reduced considerably.

Second Embodiment

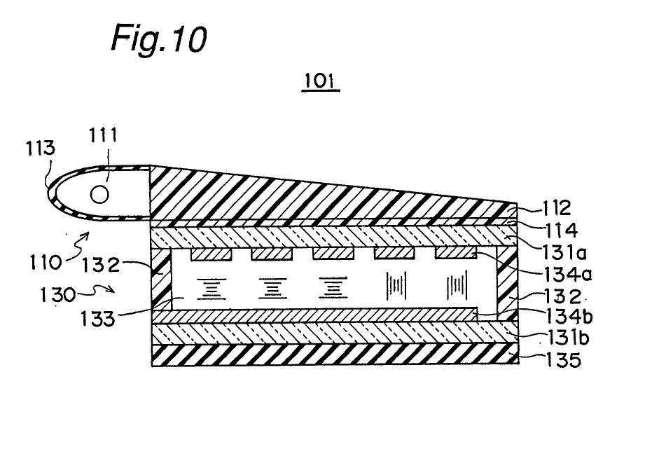

FIG. 10 shows a chiral nematic LCD device generally indicated by reference numeral 101. Similar to the first embodiment, generally the LCD device 101 includes a front light unit generally indicated by reference numeral 110 for lighting and a chiral nematic green LC display panel generally indicated by reference numeral 130.

The front light unit 110 has a light source 111 for emitting light, a light guide 112 for effectively guiding light from the light source 111 toward the LC display panel or element 130, a reflector 113 for reflecting light from the light source 111 toward the light guide 112, and anti-reflection layer 114 positioned between the light guide 112 and the LC display panel 130. Used for the light source 111 is a lamp made from LED for emitting green light. To this end, light from the light source 111 has a peak in the wavelength of about 540 nm.

The chiral nematic LC dispaly panel 130 has a pair of opposed transparent substrates 131a and 131b for defining a fine gap therebetween, a sealing member 132 positioned between and along peripheral edges of the substrates, and a liquid crystal 133 filled in the chamber between the substrates. Preferably, the liquid crystal 133 has a cholesteric phase at the room temperature. Opposing surfaces of the substrates 131a and 131b bear a number of transparent strip-like electrodes 134a and 134b positioned at regular intervals, respectively. The electrodes 134a and 134b are directed in different directions to cross perpendicularly so that each intersection of the electrodes defines a pixel in an image displayed by the panel. Also, the display panel 130 has a light absorbing layer 135 on a rear surface of the lower substrate 131b for substantially absorbing all visible light.

In operation of the chiral nematic LCD device 101, green light emitted from the light source 111 of the front light unit 110 is effectively collected by the reflector 113 and then introduced into the light guide 112. As can be seen from the drawing, the light guide is tapered so that a thickness thereof decreases in proportion to a distance from its one end adjacent the light source. This allows green light to be illuminated substantially evenly at every portion of the LC display panel 130. In addition, as described in the first embodiment, for the effective transmission of light from the light source 111 into the LC display panel 130, a front surface of the light guide 112 has a number of small stepped or jagged convex and/or concave portions. Light projected from the light guide 112 is transmitted through the anti-reflection layer 114 into the LC display panel 130. At this moment, the anti-reflection layer 114 minimizes a reflection of light at the boundary of the front light unit 110 and the LC display panel 130.

According to the chiral nematic LC display panel 130, the liquid crystal 133 changes between a planer state and a focal conic state by the application of pulse between the opposing electrodes 134. For example, an application of a first pulse between the electrodes defining a certain pixel will change the liquid crystal 133 therein into planer state. In this state, light introduced in the pixel, in particular a part of incident light having a wavelength of green, is reflected at the pixel. When applying a second pulse, different from the first pulse in voltage, to the electrodes, the liquid crystal 133 therein changes into the focal conic state. This allows a major part of incident light to transmit the liquid crystal and then reach the light absorbing layer 135 where it is absorbed therein. As described above, the LCD panel 130 functions as a display element displaying an image by the use of a difference in intensity of reflected light, i.e., contrast between the reflecting and non-reflecting pixels.

The liquid crystal 133 exhibiting the chelesteric phase at room temperature is bistable, so that it maintains two its planer and focal conic states without the application of the pulse voltage. FIG. 2 illustrates a spectral reflection characteristic, of the liquid crystal 133 in the planer and focal conic states. The graph clarifies that the reflection characteristic in the planer state indicated by solid curve presents a Gaussian distribution having a peak of wavelength at about 545 nm. Hereinafter, a ratio of light reflected by the liquid crystal 133 in the planer state against light introduced in the panel will be referred to as “green liquid crystal reflectance” and indicated by “f_{b}(λ)” wherein λ represents wavelength of light.

On the other hand, the liquid crystal in the focal conic state causes most of visible light to pass therethrough but a small part of visible light to reflect therefrom. The reflected light ranges over the entire wavelength. It can be thought that light is in part reflected at various boundaries between the liquid crystal 133 and transparent electrodes 134, transparent electrodes 134 and transparent substrates 131a and 131b, and transparent substrate 131b and light absorbing layer 135, for example. Also, it can be assumed that the reflection of light observed in the focal conic state is derived from the reflection at the boundaries. The following discussions will be made based upon this assumption. Also, a ratio of light reflected at the boundaries against light introduced in the panel will be referred to as “boundary reflectance” and indicated by “r_{b}(λ)” wherein λ represents wavelength of light.

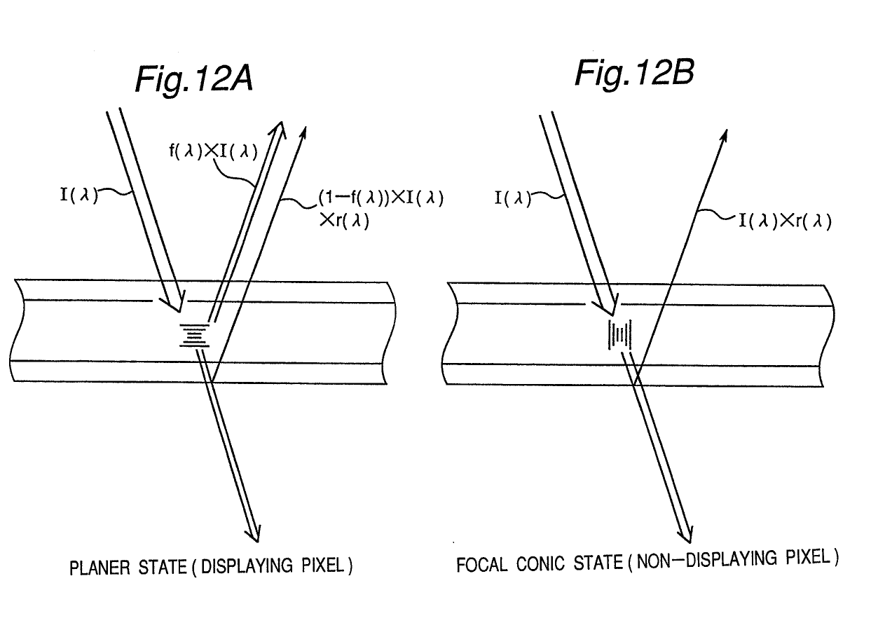

Referring to FIGS. 12A and 12B showing enlarged schematic cross sections of the liquid crystal panel in which the liquid crystal is in the planer and focal conic states, respectively, a contrast between the reflecting pixel and the non-reflecting pixel will be described hereinafter. For clarity, the opposing electrodes are omitted from the drawings.

When the liquid crystal takes the planer state as shown in FIG. 12A, incident light having a certain wavelength λ and a certain intensity I(λ) is reflected at both the liquid crystal and the boundaries described above. An intensity of reflected light Rₚ(X) is expressed by the following equation (1):

Rₚ=f_{b}(λ)·I(λ)+[1−f_{b}(λ)]·I(λ)·r_{b}(λ) (1)

On the other hand, when the liquid crystal takes the focal conic state as shown in FIG. 12B, incident light is reflected at the boundaries and therefore an intensity of reflected light R_{f}(λ) is expressed by the following equation (2):

R_{f}=r_{b}(λ)·I(λ) (2)

Using those equations, a contrast C(λ) of light at between reflecting and non-reflecting pixels is expressed as follows:

$$\begin{matrix}C ( λ ) = {R}_{p} / {R}_{f} \\ = {f}_{b} ( λ ) \cdot [ 1 / {r}_{b} ( λ ) - 1 ] + 1\end{matrix} \qquad ( 3 )$$

As can be seen from equation (3), the contrast C(λ) increases in proportion to the reflectance f_{b}(λ) Also, the contrast C(λ) increases as the reflectance r_{b}(λ) decreases. As described above, the reflectance r_{b}(λ) is almost independent of the wavelength so that it ranges over the entire wavelength. Therefore, an elevated contrast is expected by the illumination of light having a wavelength λ that provides a greater influence on the reflectance f_{b}(λ). This means that light having a wavelength at or about at which the liquid crystal presents the peak of reflectance results in an elevated contrast.

Contrasts may be used as criterions for the evaluation of the resultant image, which are classified based on the wavelength, as shown in the following table 1:

TABLE 1

| Contrast | Image quality |
|---|---|
| C (λ) < 2 | Low |
| 2 ≦ C (λ) < 5 | Moderate (No practical problem) |
| 5 ≦ C (λ) | High |

Using equation (3), “C(λ)>2” is expressed by the following inequality (4):

[f_{b}(λ)+1]·[1−r_{b}(λ)]>1 (4)

Likewise, “C(λ)>5” is expressed by the following inequality (5):

[f_{b}(λ)+4][1−r_{b}(λ)]>4 (5)

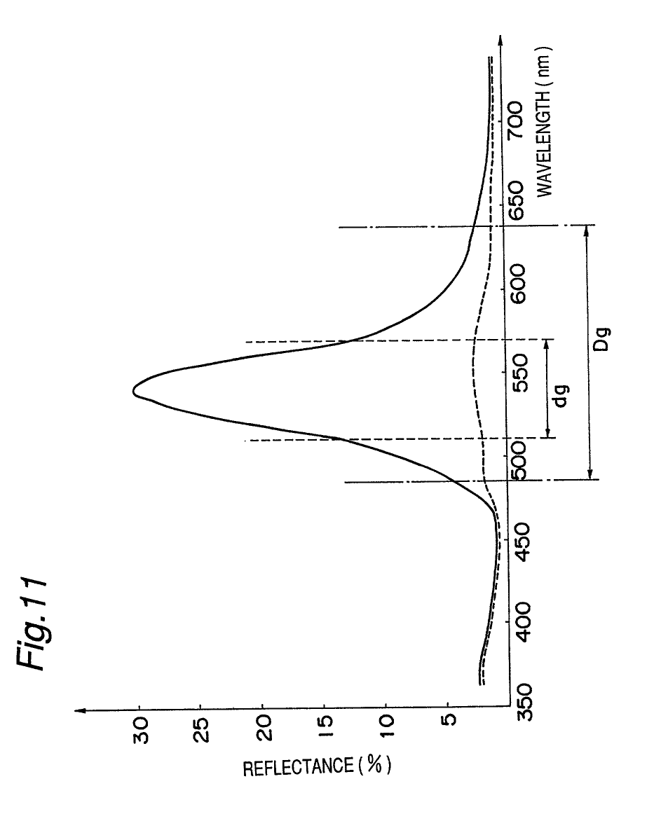

Ranges of wavelength meeting respective inequalities (4) and (5) can be read from the graph shown in FIG. 11, which are shown at D_{g} and d_{g} in the same drawing. Namely, the reflection having a contrast C(λ) of more than “2” is obtained when the liquid crystal 133 is illuminated by light within the wavelength range D_{g}. Also, the reflection having a contrast C(λ) of more than “5” is obtained when the liquid crystal 133 is illuminated by light within the wavelength range d_{g}.

Accordingly, the wavelength of light projected from the front light 10 for illumination of the green LCD panel 130 corresponds to the wavelength (about 540 nm) at which the liquid crystal 133 presents the maximum reflectance. For this purpose, the light source 11 uses a green LED lamp emitting light presenting the peak intensity at wavelength of about 540 nm which falls within the wavelength range d_{g} corresponding to contrast C(λ) more than “5”. This allows the chiral nematic LCD device 1 to provide a high quality image.

The above-described ranges are determined for each liquid crystal. Namely, although descriptions have been made to liquid crystal for providing green image, the ranges can be determined for another liquid crystals providing different color images. For example, for the LCD device with an LC layer for displaying specific color, e.g., blue, green, or red, ranges D_{b} and d_{b}, D_{g} and d_{g}, or Dᵣ and dᵣ are determined independently.

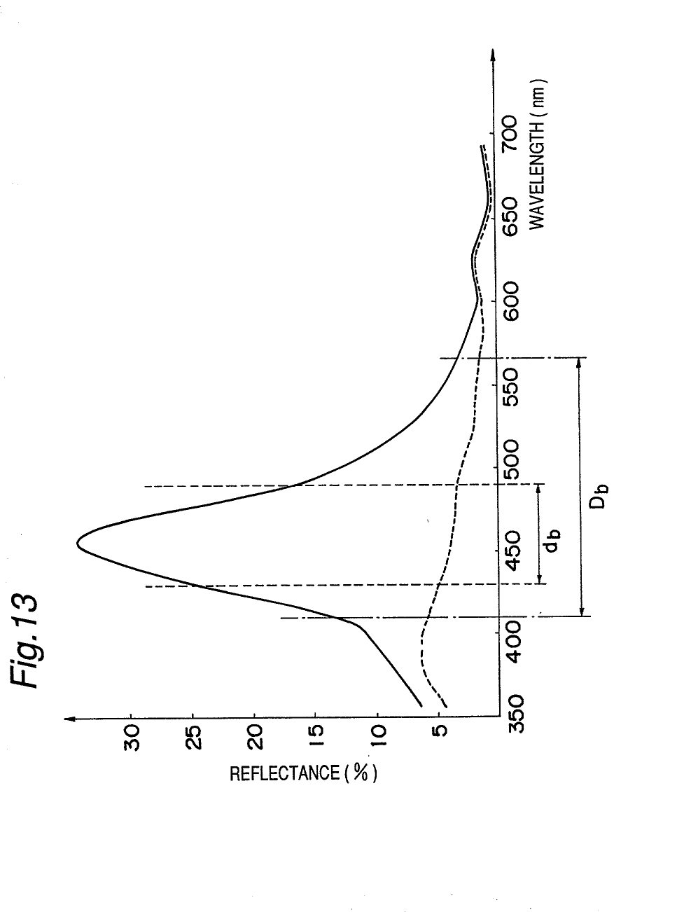

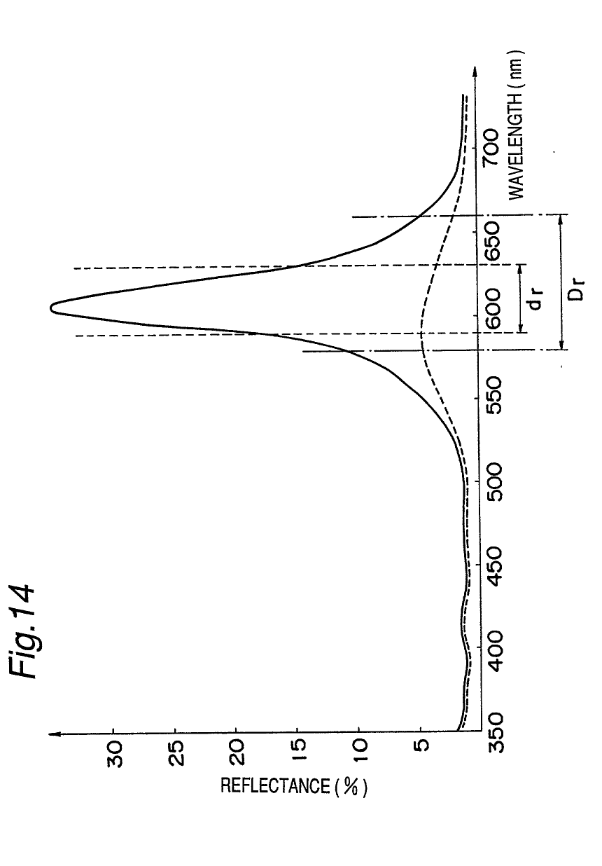

Examples of the ranges are shown in the following table 2 (see FIGS. 13 and 14):

TABLE 2

| | |
|---|---|
| Color of | Range of Wavelength [nm] |

| LC | D_{g} (C(λ) > 2) | d_{g} (C(λ) > 5) |
|---|---|---|
| Blue | 410-560 | 430-490 |
| Green | 485-640 | 510-570 |
| Red | 580-660 | 590-630 |

This table indicates that the illumination of light having specific ranges of wavelength as its major part will result in an image having an elevated contrast. Also, the front light that uses blue LED (red LED) emitting light with a peak intensity at about 450 nm (610 nm) is preferably employed for the blue LCD panel (red LCD panel), which realizes an improved chiral nematic LCD device capable of displaying an image of high quality.

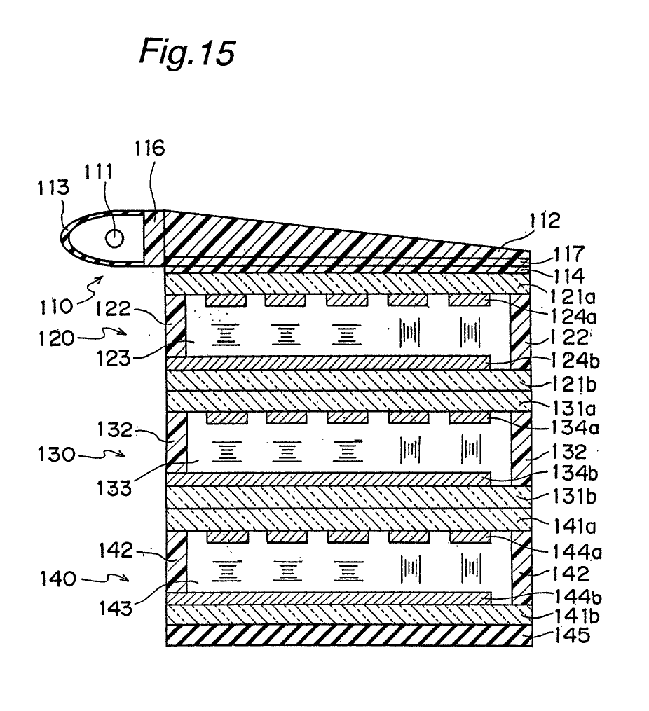

Referring to FIG. 15, another chiral nematic RGB LCD device according to the embodiment will be described hereinafter. The chiral nematic RGB LCD device generally indicated by reference numeral 102 is similar to that indicated in FIG. 10 except that the device includes three chiral nematic LC display panels 120, 130 and 140 arranged one on top the other.

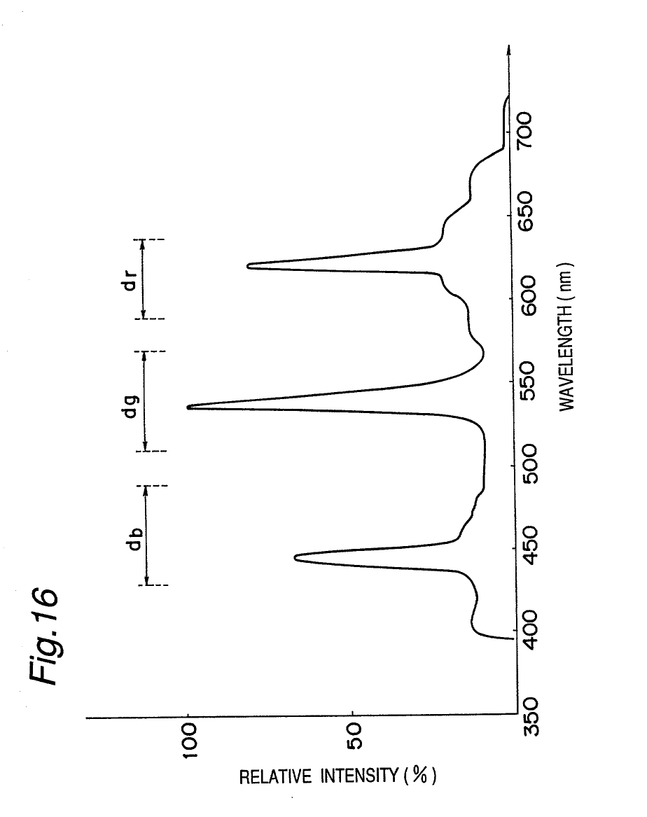

In this arrangement, as shown in FIG. 16, the light source 111 emitting light having peaks (local maximum points) of intensity at wavelengths corresponding to blue, green, and red is preferably used. More preferably, light includes peaks (local maximum points) of intensity within the ranges of 430-490 nm (blue), 510-570 nm (green), and 590-630 nm (red). The light source may be any kind of light source such as three-wavelength fluorescent lamp or a combination of three light sources each emitting blue, green, and red light. According to the arrangement, the chiral nematic RGB LCD device displays a clear and high contrast image

It should be noted that although one aspect of the present invention has been fully described for the single-layer and three-layer LCD device, it can equally be applied to another LCD device having two or more layers.

Third Embodiment

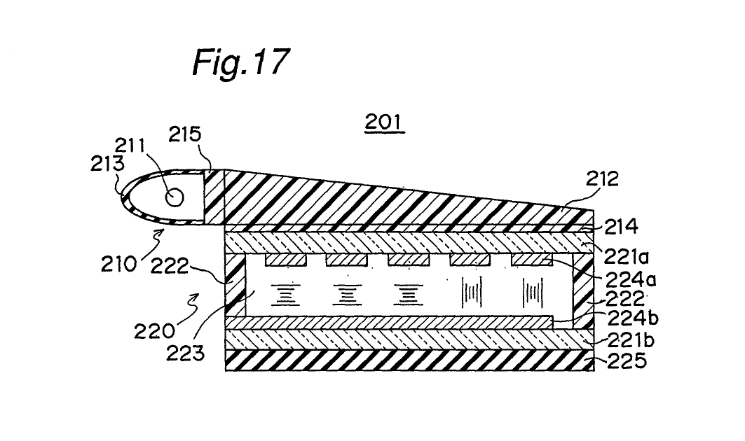

FIG. 17 shows another chiral nematic LCD device generally indicated by reference numeral 201 according to the third embodiment of the present invention. As can be seen from the drawing, the LCD device 201 is similar to that in the second embodiment except that a circular polarizing and separating plate 215 is provided between the light source 211 and the light guide 212. For example, the circular polarizing and separating plate 215 is made from a film of cholesteric liquid crystal so that it allows only right circular polarized light to pass therethrough. Preferably, the circular polarizing and separating plate 215 is positioned outside a viewing angle or field of the viewer.

In operation of the chiral nematic LCD device 201, light from the light source 211 is effectively collected by the reflector 213 and then directed into the circular polarizing and separating plate 215. The plate 215 selectively transmits right circular polarized light and reflects left circular polarized light. Preferably, in order to provide a uniform polarization for a reflecting surface of the reflector 213, it may be covered by a diffusion material or layer. This causes light from the light source 211 to be effectively transformed into right circular polarized light. Namely, even though light from the light source 211 has no polarization, it will be transformed into light with “right” polarized light. As a result, the front light unit 210 projects only right circular polarized light (light with right polarization) but free from left circular polarized light to the LC display panel 220.

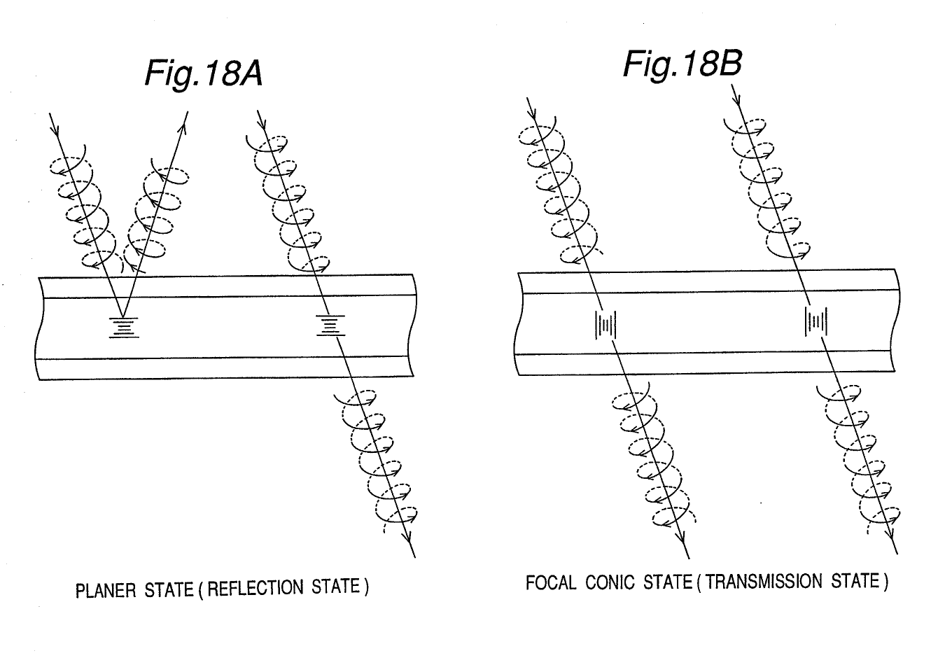

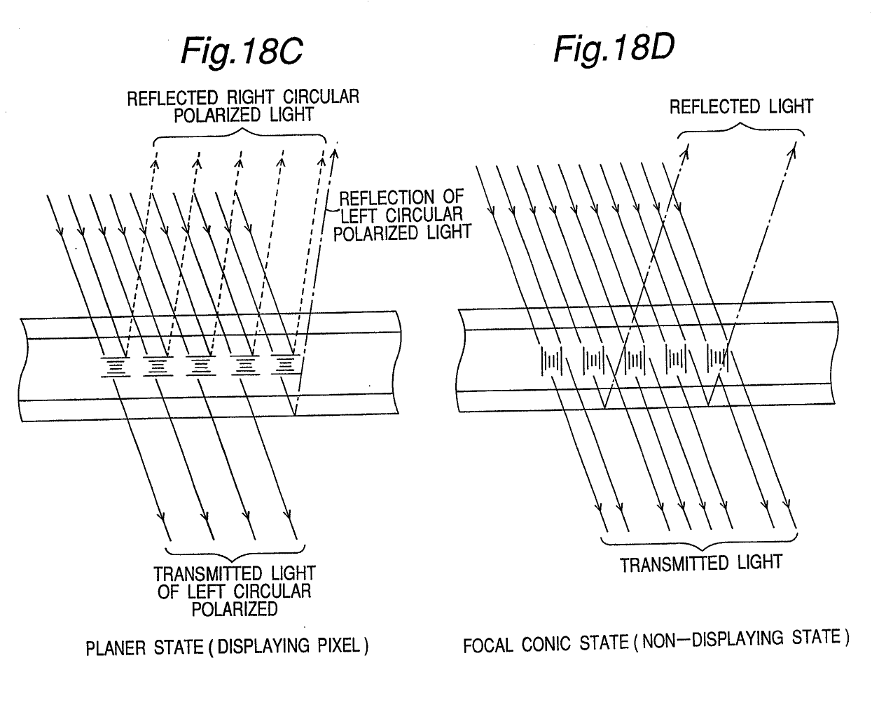

The liquid crystal 223 in cholesteric phase takes either one of two stable states, i.e., planer and focal conic states, even while it is not biased with voltage. The liquid crystal in the planer state 223 selectively reflects right circular polarized light and transmits left circular polarized light. The liquid crystal in the focal conic state 223 transmits not only right circular polarized light but also left circular polarized light (see FIGS. 18A is to 18D).

As described above, the chiral nematic LC display panel 220 includes the upper and lower transparent electrodes 224 arranged in the form of matrix, so that by an application of pulse voltages between the electrodes the liquid material 223 filled between the electrodes is changed between the planer and focal conic states.

In the image formation, the upper and lower electrodes 224 defining a pixel of the displaying image are applied with a pulse of first voltage by which the liquid material between them is set to be planer state. This results in that right circular polarized light entered the displaying pixel is reflected by the liquid material 223 and left circular polarized light is transmitted through the liquid material 223. On the other hand, the upper and lower electrodes 224 not defining the pixel of the displaying image are applied with another pulse of second voltage by which the liquid material between them is set to be focal conic state. This results in that light entered the non-displaying pixel is entirely transmitted through the liquid material and then absorbed by the light absorbing layer 225. Namely, right circular polarized light is reflected from the displaying pixel and is transmitted through the non-displaying pixel. As described above, the chiral nematic LC display panel 220 functions as a display element by changing the intensity of reflected light (contrast) between the displaying and non-displaying pixels.

Further discussions will be made to the contrast of the reflected light between the displaying and non-displaying pixels. A part of incident light is reflected at the boundaries between the liquid crystal 223 and electrode 24, electrode 24 and substrates 221a and 221b, and substrate 221b and light absorbing layer 225, for example, before being absorbed by the light absorbing layer 225, irrespective of whether the liquid crystal takes planer or focal conic state.

Therefor, intensities Rp and Rf of light reflected at the displaying pixel and non-displaying pixel are expressed by the following equations (6) and (7), respectively:

Rₚ=L (6)

R_{f}=L·r (7)

wherein L represents an intensity of light (right circular polarized light) projected from the front light unit 210, and r represents a noise reflectance (0≦r≦1).

In principle, the entire right circular polarized light from the front light unit 210 is theoretically reflected by the displaying pixel without being transmitted therethrough. Also, a major part of the right circular polarized light transmits the non-displaying pixel but a minor part thereof reflects at the boundaries. A contrast C of reflected light between the displaying and non-displaying pixels is expressed by the following equation 8:

C=Rₚ/R_{f}=1/r (8)

If the noise reflectance of the chiral nematic liquid crystal 220 is 20%, the contrast C₀ of the front light unit using natural light is ⅓ which is calculated by the following equation (9):

C₀=Rₚ/R_{f}=(1+r)/2r (9)

On the other hand, under the same condition, the contrast C of the front light unit using right circular polarized light is ⅕ which is calculated by the equation (8). This means that the chiral nematic LCD device 201 improves the quality of the displaying image.

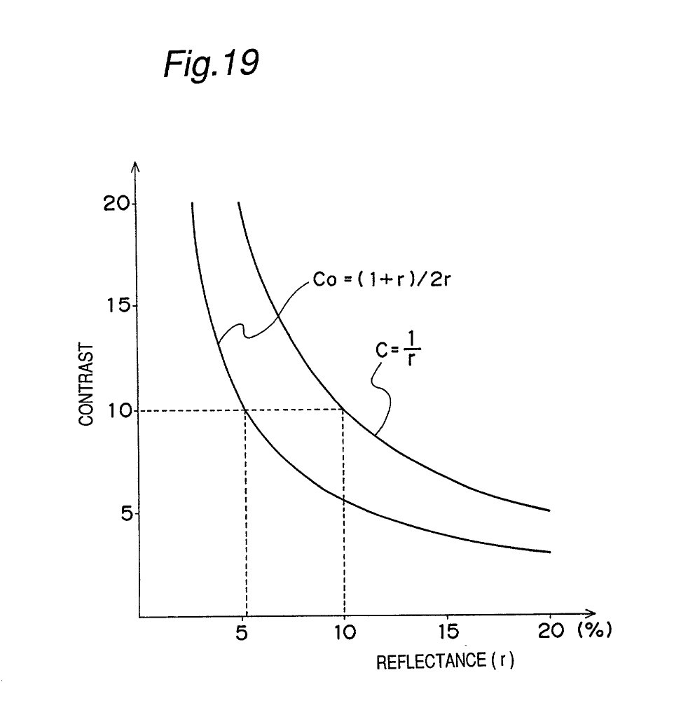

FIG. 19 shows reflectance versus contrast characteristics of the chiral nematic LC display panels using natural light and right circular polarized light. As can be seen from the graph, the contrast C of the chiral nematic LCD device 201 using right circular polarized light is about two times as much as that using natural light. Therefore, the image quality of the resultant image displayed in the chiral nematic LCD device of the above-mentioned structure is improved considerably.

Although in the above description light projected into the LC display panel 220 consists of right circular polarized light from the front light unit 210, it may additionally include non-polarized natural light. Even in this instance, the contrast of the displaying image is so improved, which will be described hereinafter.

Specifically, light intensities at the displaying pixel and non-displaying pixel are expressed by the following equations (10) and (11):

Rₚ=L₁+(1+r)·L₂/2 (10)

R_{f}=L₁·r+L₂·r=(L₁+L₂)·r (11)

wherein L₁ represents an intensity of light (right circular polarized light) from the front light unit, L₂ represents an intensity of natural light (non-polarized light), and r represents a noise reflectance (0≦r≦1).

At this moment, the light intensity of light illuminated onto the LC display panel 220 is (L₁+L₂). Then, a polarization p corresponds to a polarized component (L₁) in the total intensity of light and therefore is expressed by the following equation (12):

$$\begin{matrix}p = [ ( {L}_{1} + {L}_{2} / 2 ) - {L}_{2} / 2 ] / ( {L}_{1} + {L}_{2} ) \\ = {L}_{1} / ( {L}_{1} + {L}_{2} )\end{matrix} \qquad ( 12 )$$

In this equation, since L1 and L2 are greater than zero (L₁>0, L₂>0), the polarization p ranges between zero to one (0<p<1). Also, since right circular polarized light occupies the major part of light, the polarization p takes a positive value.

On the other hand, light from the front light unit 210 (right circular polarized light) is reflected from the displaying pixel without being transmitted therethrough. Also, it is transmitted through the non-displaying pixel but is in part reflected at the boundaries. Therefore, a contrast between the displaying and non-displaying pixels is expressed by the following equation (13):

$$\begin{matrix}{C}_{1} = {R}_{p} / {R}_{f} \\ = [ 1 + r + p \cdot ( 1 - r ) ] \cdot 2 r\end{matrix} \qquad ( 13 )$$

Then, a difference between the contrast C₁ in which not only natural light but also right circular polarized light from the front light unit is illuminated to the LC display panel and the contrast C₀ in which only natural light is illuminated to the LC display panel is given by the following equation (14):

C₁−C₀=p·(1−r)/2r (14)

It should noted here that if the polarization is positive, the contrast C₁ is always greater than C₀. This in turn means that by making the polarization positive take a positive value an image with high contrast and then high quality is displayed. In this instance, the chiral nematic LCD device 201 with the front light unit 210 has a contrast that exists between two characteristic curves shown in FIG. 19.

It should be noted that if the chiral nematic LC display panel 220 reflects only left circular polarized light rather than right circular polarized light, the front light unit is designed to project only left circular polarized light.

Also, although the circular polarizing and separating member 215 is used for projecting only right circular polarized light, it may be replaced with a circular polarizing member capable of transmitting only right circular polarized light and absorbing left circular polarized light.

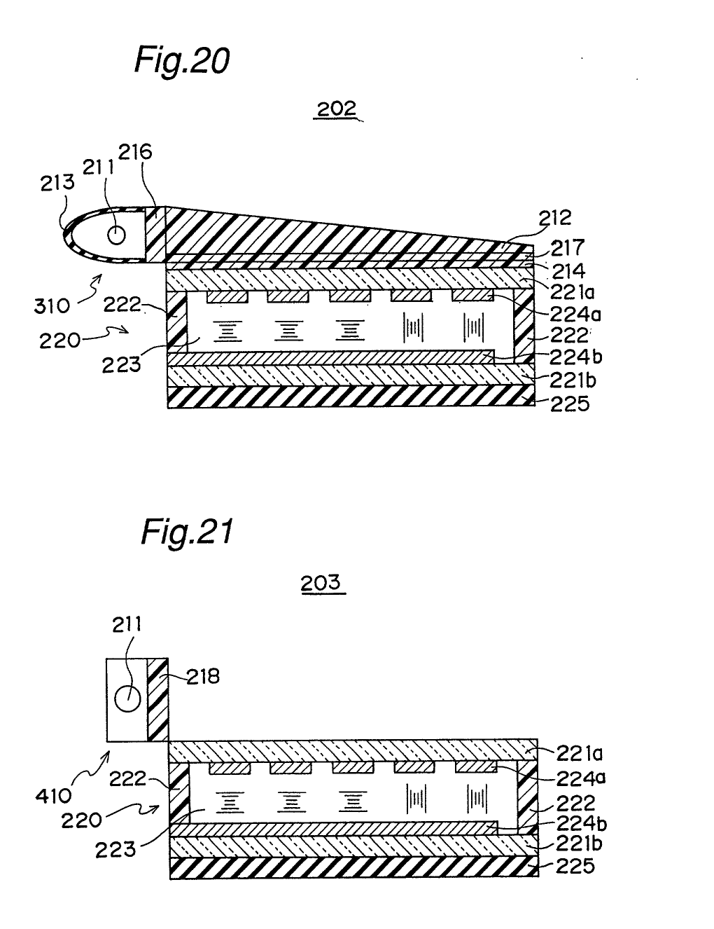

Referring to FIG. 20, there is shown another chiral nematic LCD device 202. The device 202 is similar to the above-described LCD device 201 except that a linear polarizing and separating member or plate 216 and a phase plate 217 are used for selectively projecting right circular polarized light into the LC display panel. The linear polarizing and separating plate 216 is provided between the light source 211 and the light guide 212, and the phase plate 217 is provided between the light guide 212 and the anti-reflection layer 214. One example of the linear polarizing and separating plate 216 is available from 3M (Minnesota Mining and Manufacturing Company) in the U.S.A under the tradename of DBEF. The phase plate 217 may be a commercially available “λ/4 plate”.

With the arrangement, light from the front light unit 310 is collected effectively and then projected into the liner polarizing and separating plate 216. The linear polarizing and separating plate 216 transmits only linear polarized light and reflects both right and left circular polarized light. Preferably, a surface of the reflector is covered with a diffusion layer in order to have a uniform polarization of light. Light from the light source 211 is transmitted through the linear polarizing and separating plate 216 where it is effectively transformed into linear polarized light. The linear polarized light is transmitted into the phase plate 217 where it is transformed into right circular polarized light and then projected to the LC display panel 220. As described above, the front light unit 310 transforms light from the light source 211 into right circular polarized light. Also, the right circular polarized light allows the LC display panel 220 to provide an improved contrast and then high quality image. It should be noted that the linear polarizing and separating plate 216 may be replaced with another linear polarizing plate that transmits only linear polarized light and absorbs both right and left circular polarized light.

Referring to FIG. 21, there is shown another modification of the chiral nematic LCD device in which the light guide is omitted therefrom. In this modification, the front light unit 410 has only the light source 211 and the polarizing member 218 for transforming light from the light source 211 into right circular polarized light. The polarizing member 218 may be a circular polarizing plate, or a combination of the linear polarizing plate and the phase plate. Alternatively, the polarizing member may be a combination of a circular polarizing and separating plate and the reflector, or another combination of a linear polarizing and separating plate, a phase plate, and the reflector.

According to this arrangement, various adverse affects such as light absorption, reflection, and diffusion are eliminated which would otherwise be caused by the existence of the light guide. Also, the front light unit 410 positioned above the LC display panel 210 uniformly illuminates the LC display panel entirely. This allows the front light unit 410 to transform light from the light source 211 into right circular polarized light. Then, the right circular polarized light allows the LC display panel 220 to provide an improved contrast and then quality to the resultant image.

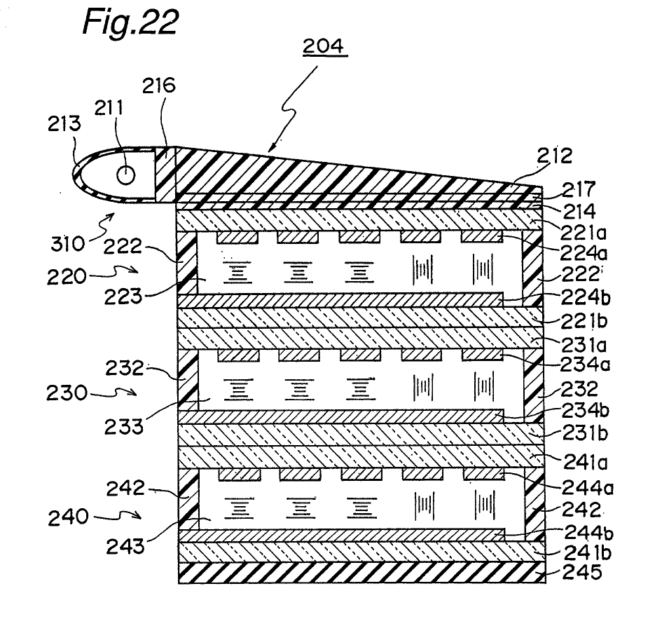

Referring to FIG. 22, there is shown another modification of the chiral nematic LCD device having three LCD elements 220, 230, and 240 for reflecting light having wavelengths associated with blue, green, and red, respectively. In this arrangement, light is in part reflected at various boundaries including respective surfaces of the LCD elements, unavoidably increasing the noise reflectance r. Notwithstanding with this, according to this embodiment an increase of the noise reflectance can be compensated by the increase of the contrast between the displaying and non-displaying pixels.

Specifically, as can be seen from FIG. 19, for having a contrast of more than 10 to improve the quality of the displaying image, the device without any polarizing member is required to maintain the noise reflectance below about 5.3. On the other hand, the front light unit of the present invention ensures a contrast of more than 10 if the noise reflectance is less than 10. This enlarges an acceptable range of noise reflectance for a contrast of the reflected light. Also, the contrast can be increased so easily than to decrease the noise reflectance by changing a combination of, for example, the liquid crystal material and the material of the transparent electrodes, substrates, insulating layer, orientation layer and other functional layers. Of course, those changes if they are combined with the present invention are useful for increasing the displaying image.

What is claimed is:

1. A reflective liquid crystal display apparatus, comprising:
a liquid crystal panel having a plurality of liquid crystal layers, each liquid crystal layer including a cholesteric liquid crystal that changes between a transmission state in which the liquid crystal transmits visible light and a reflection state in which the liquid crystal reflects a selected part of said visible light, said selected part of said visible light in one liquid crystal layer being different from that or those of remaining liquid crystal layer or layers; and
a light guide having a front, a rear, and a peripheral surface connecting between said front and rear surfaces, said light guide being positioned so that said rear surface opposes said liquid crystal panel, wherein light transmitted from said peripheral surface is transmitted through said rear surface to said liquid crystal panel.

2. A reflective liquid crystal display apparatus in accordance with claim 1, wherein said liquid crystal panel supports a light absorbing layer on a rear surface thereof.

3. A reflective liquid crystal display apparatus in accordance with claim 1, further comprising a light source for projecting light into said light guide through said peripheral surface of said light guide.

4. A reflective liquid crystal display apparatus in accordance with claim 1, further comprising a lighting portion for guiding light available into said light guide.

5. A reflective liquid crystal display apparatus in accordance with claim 1, further comprising a light source provided for projecting light into said light guide and a lighting portion for guiding light available into said light guide, said light source and said lighting portion being arranged adjacent said peripheral surface of said light guide.

6. A reflective liquid crystal display apparatus in accordance with claim 1, further comprising a housing for holding said light source and said lighting portion.

7. A reflective liquid crystal display apparatus in accordance with claim 4, further comprising a housing for holding said light guide and said liquid crystal panel so that said a front surface of said light guide is exposed the atmosphere, wherein said lighting portion is defined in said housing.

8. A reflective liquid crystal display apparatus in accordance with claim 7, wherein said lighting portion is a curved surface portion of said housing.

9. A reflective liquid crystal display apparatus in accordance with claim 7, wherein said lighting portion is an inclined surface portion which is formed in said peripheral surface of said light guide.

10. A reflective liquid crystal display apparatus in accordance with claim 1, further comprising a transparent member which covers said front surface of said light guide.

11. A reflective liquid crystal display apparatus in accordance with claim 1, further comprising a controller for controlling an amount of light emitted from said light source.

12. A reflective liquid crystal display apparatus in accordance with claim 1, wherein said liquid crystal panel has first to third liquid crystal layers for selectively reflecting red, blue, and green light, respectively.

13. A liquid crystal display apparatus, comprising:
a liquid crystal display element for selectively reflecting light with a certain wavelength range and thereby displaying an image; and
a front light unit for projecting light through one surface of said liquid crystal display element adjacent a viewer, said light having a peak of intensity within said certain wavelength range.

14. A liquid crystal display apparatus, comprising:
a liquid crystal display element having a plurality of liquid crystal layers positioned one on top the other, said liquid crystal layers selectively reflecting light with respective wavelength ranges and thereby displaying respective parts of an image; and
a front light unit for projecting light through one surface of said liquid crystal display element adjacent a viewer, said light having at least one peak of intensity within any one of said wavelength ranges.

15. A liquid crystal display apparatus in accordance with claim 14, wherein said liquid crystal panel has two liquid crystal layers selectively reflecting light with different wavelength ranges.

16. A liquid crystal display apparatus in accordance with claim 14, wherein said light from said front light unit has two or more peaks of intensity within said wavelength ranges, respectively.

17. A liquid crystal display apparatus in accordance with claim 14, wherein said liquid crystal element includes at least three liquid crystal layers for selectively reflecting blue, green, and red, respectively.

18. A liquid crystal display apparatus in accordance with claim 14, wherein each of said wavelength ranges is defined so that a contrast represented by a ratio of a reflectance of said liquid crystal in a reflecting state to a reflectance of said liquid crystal in a non-reflecting state is “2” or more.

19. A liquid crystal display apparatus in accordance with claim 14, wherein each of said ranges of wavelength is defined so that a contrast represented by a ratio of a reflectance of said liquid crystal in a reflecting state to a reflectance of said liquid crystal in a non-reflecting state is “5” or more.

20. A liquid crystal display apparatus in accordance with claim 14, further comprising a light absorbing layer on a rear surface of said liquid crystal display element.

21. A liquid crystal display apparatus in accordance with claim 14, wherein each liquid crystal layer comprises a cholesteric liquid crystal.

22. A liquid crystal display apparatus in accordance with claim 14, wherein each liquid crystal layer comprises a chiral nematic liquid crystal that is a mixture of a nematic liquid crystal and a chiral material.

23. An illumination unit, comprising:
a light source that projects light to a liquid crystal display element, said liquid crystal display element displaying an image by selectively reflecting a certain part of incident light having a certain wavelength range, said light source emitting light having a peak of intensity within said range of wavelength.

24. An illumination unit, comprising:
a light source that projects light to a liquid crystal display element, said liquid crystal display element having a plurality of liquid crystal layers each reflecting certain parts of incident light having respective wavelength ranges, said light source emitting light having at least one peak of intensity within any one of said ranges of wavelength.

25. An illumination unit in accordance with claim 24, wherein said light from said light source has two or more peaks of intensity within said wavelength ranges, respectively.

26. An illumination unit in accordance with claim 24, wherein said liquid crystal displaying element includes at least three liquid crystal layers for selectively reflecting blue, green, and red, respectively.

27. An illumination unit in accordance with claim 25, wherein said light source has a plurality of light emitting elements emitting lights having said peaks of intensity within said wavelength ranges, respectively.

28. An illumination unit in accordance with claim 25, wherein said light source has a single light emitting element emitting lights having said peaks of intensity within said wavelength ranges, respectively.

29. A liquid crystal display apparatus, comprising:
a liquid crystal displaying element for selectively reflecting a light with a positive or negative first polarization; and
an illumination unit for projecting light to one surface of said liquid crystal display element adjacent to a viewer, said projected light having a second polarization having the same polarity as said first polarization.

30. A liquid crystal display apparatus in accordance with claim 29, further comprising a light absorbing layer on an opposite surface of said liquid crystal display element.

31. A liquid crystal display apparatus in accordance with claim 29, wherein said illumination unit includes a light source for projecting said light to said liquid crystal display element and a polarization member for changing said projected light into another light having said first polarization.

32. A liquid crystal display apparatus in accordance with claim 31, wherein said polarization member is positioned outside of a range within which the viewer can view an image displayed on said display apparatus.

33. A liquid crystal display apparatus in accordance with claim 29, further comprising a light guide for guiding said light with said first polarization into said one surface of said liquid crystal element so that said light is two-dimensionally projected on said one surface.

34. A liquid crystal display apparatus in accordance with claim 29, wherein said liquid crystal display element has a cholesteric liquid crystal which exhibits a selective reflection characteristic.

35. A liquid crystal display apparatus in accordance with claim 29, wherein said liquid crystal display element has a cholesteric liquid crystal that is a mixture of nematic liquid crystal and a chiral material.

36. A liquid crystal display apparatus in accordance with claim 1, wherein said liquid crystal display element is made of a plurality of liquid crystal layers positioned one on top the other.

37. An illumination unit for illuminating a surface of a displaying element adjacent a viewer, comprising:
a light source that emits light with a positive or negative polarization.

38. An illumination unit for illuminating a surface of a display element adjacent a viewer, comprising:
a light source for emitting light; and
a polarization member for changing a polarization of said light emitted from said light source;
wherein said light is transmitted through said polarization member.

39. An illumination unit for illuminating a surface of a display element adjacent a viewer, comprising:
a light source for emitting right or left circle polarized light; and
a polarization member for decreasing said right or left circle polarized light;
wherein said light is transmitted through said polarization member.

40. An illumination unit for illuminating a surface of a display element adjacent a viewer, comprising:
a light source for emitting right;
a polarization member for changing a polarization of said light emitted from said light source; and
a light guide for guiding said emitted light, said light guide being positioned adjacent said polarization member.

41. An illumination unit in accordance with claim 37, wherein said display element is a liquid crystal display element for selectively reflecting light with positive or negative first polarization, and another light having a second polarization with the same polarity as said first polarization is illuminated through said surface of said display element.

42. An illumination unit in accordance with claim 38, wherein said polarization member is a circular polarization member or circular polarizing and separating member.

43. An illumination unit in accordance with claim 38, wherein said polarization member has:
one of a linear polarizing plate and a linear polarizing and separating plate; and
a phase plate.
